(19) United States
(12) Patent Application Publication
(10) Pub. No.: US 2024/0307819 A1
(43) Pub. Date: Sep. 19, 2024

(54) ELECTROCHEMICAL TARGET SPECIES CAPTURE WITH A REDOX-ACTIVE AMINE

(71) Applicant: Massachusetts Institute of Technology, Cambridge, MA (US)

(72) Inventors: Trevor Alan Hatton, Sudbury, MA (US); Hyowon Seo, Cambridge, MA (US)

(73) Assignee: Massachusetts Institute of Technology, Cambridge, MA (US)

(21) Appl. No.: 18/574,001

(22) PCT Filed: Jun. 24, 2022
(86) PCT No.: PCT/US2022/034818

§ 371 Date: Dec. 22, 2023

Related U.S. Application Data
(60) Provisional application No. 63/214,845, filed on Jun. 25, 2021.

(51) Int. Cl. B01D 53/32

(52) U.S. Cl. CPC B01D 53/326; B01D 2257/504

(57) ABSTRACT

The present disclosure relates to electrochemical target species (e.g., carbon dioxide) capture and release with a redox-active amine. Associated systems and articles are also described.

### RELATED APPLICATIONS

This application claims priority under 35 U.S.C. § 119(e) to U.S. Provisional Patent Application No. 63/214,845, filed Jun. 25, 2021, and entitled “Electrochemical Carbon Dioxide Capture and Release with a Redox-Active Amine,” which is incorporated herein by reference in its entirety for all purposes.

### TECHNICAL FIELD

Electrochemical target species capture with a redox-active amine and associated systems and articles are generally described.

### BACKGROUND

Efforts have been made to remove or separate gases from fluid mixtures. For example, over the last two decades there has been an effort to mitigate global warming by curbing anthropogenic carbon dioxide (CO₂) emission. A number of approaches, such as conventional thermal methods, have been pursued to tackle carbon dioxide capture at different stages of its production: either post combustion capturing at power plants, or concentrating it from the atmosphere, after which it is either pressurized and stored in geological formations, or it is converted to commercially useful chemical compounds. One alternative approach is electrochemical capture of gases using electroactive species.

Improved apparatuses, methods, and/or systems are desirable.

### SUMMARY

The present disclosure relates to electrochemical target species (e.g., carbon dioxide) capture and release with a redox-active amine. In some aspects, the present disclosure relates to electrochemical carbon dioxide capture and release with a redox-active amine. Associated systems and articles are also described. The subject matter of the present disclosure involves, in some cases, interrelated products, alternative solutions to a particular problem, and/or a plurality of different uses of one or more systems and/or articles.

Certain embodiments are related to methods. In some embodiments, the method comprises electrochemically reacting an amine such that the amine becomes reactive with a target species.

In some embodiments, the method comprises electrochemically reacting an amine such that a target species is captured.

In some embodiments, the method comprises electrochemically reacting (e.g., via a reduction reaction) an amine such that the amine becomes reactive with a target species (e.g., carbon dioxide); optionally, reacting the amine with the target species to capture the target species; and optionally, reacting (e.g., via an oxidation reaction) the combination of the amine and the target species such that the target species is released from the amine.

Certain embodiments are related to systems. In some embodiments, the method comprises an electrode; an amine in electronic communication with the electrode; and an inlet configured to be in fluidic communication with a source of a target species; wherein the system is configured to expose the target species to the amine.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A shows a scheme for a reaction involving an amine and a target species, according to some embodiments.

FIG. 1B shows a scheme for a reaction involving an amine and a target species, according to some embodiments.

FIG. 1C shows a scheme for a reaction involving a combination of an amine and a target species, according to some embodiments.

FIG. 1D shows a scheme for a reaction involving a combination of an amine and a target species, according to some embodiments.

FIG. 2 shows a scheme for a reaction involving electrochemically reacting an amine such that it becomes reactive with a target species and reacting the combination of the amine and the target species such that the target species is released, according to some embodiments.

FIG. 3 shows a system comprising an electrode and a chamber comprising an inlet for receiving a fluid mixture comprising a target species, according to some embodiments.

FIGS. 4A-4E relate to the reversible electrochemical process for capture and release of CO₂. FIG. 4A shows traditional thermal-swing for CO₂ capture and release using an aqueous amine solution. FIG. 4B shows reversible electrochemical capture and release of CO₂ using a redox-active amine. FIG. 4C shows a proposed working scheme for reversible electrochemical capture and release of CO₂ using the 1-AP nitrate (1) redox cycle. FIG. 4D shows quantitative 13C-NMR spectra of 1-APyl-bicarbonate 4 solution. FIG. 4E shows cyclic voltammetry of 20 mM 1-AP nitrate (1, left curve) and 20 mM (as a monomer) 1-APyl-bicarbonate 4 solutions (right curve) in water with 0.1 M potassium nitrate as a supporting electrolyte at room temperature, bubbled with nitrogen, with a platinum working electrode, at a scan rate of 20 mV/s. Potentials were recorded versus Ag/AgCl as a reference electrode.

FIGS. 5A-5F are related to electrochemical release of CO₂. FIG. 5A is a schematic of the experimental setup for CO₂ release. The electrochemical H-cell containing 1-APyl-bicarbonate 4 solution to be oxidized by a constant current at room temperature was connected to the gas flow meter and an FT-IR CO₂ sensor. In FIG. 5B, 3.5 mL 1-APyl-bicarbonate 4 solution prepared from 0.2 M 1-AP nitrate (1) solution was oxidized by a constant current of 50 mA. The amount of released CO₂ (curve A) and electron utilization (curve B) are shown versus electric charge. FIG. 5C shows results for 3.5 mL of 0.4 M solution (as a monomer) by 100 mA. FIG. 5D shows results for 3.5 mL of 1 M solution (as a monomer) by 100 mA. FIG. 5E shows results for 3.5 mL of 2 M solution (as a monomer) by 200 mA. FIG. 5F shows CO₂ release profiles of CO₂ (mmol) normalized by total amine amount (mmol) versus the electric charge (mmol) normalized by total amine amount (mmol) of 0.2, 0.4, 1, and 2 M solutions (as a monomer).

FIGS. 6A-6D are related to CO₂ absorption dynamics in 1-APyl radical 2 solutions. FIG. 6A shows CO₂ absorption profiles at CO₂ inlet gas stream concentrations of 4, 15, and 100%. 0.2 M 1-APyl radical 2 solution in 1 mL of water was contacted with the gas at a flow rate of 3.3 mL/min at room temperature. FIG. 6B shows CO₂ absorption profiles for 1 and 4% CO₂ inlet gas streams at a smaller scale. 1 mL of 0.04 M 1-APyl radical 2 solution was contacted with the gas at a flow rate of 3.3 mL/min at room temperature. FIG. 6C shows normalized CO₂ absorption profiles. FIG. 6D shows a comparison of the CO₂ absorption profile for 1-APyl radical 2 (0.2 M in 1 mL of water) to those for ethylenediamine (EDA, 0.34 M in 1 mL of water, 19% of dicarbamate formation was observed by 1H-NMR) and monocthanolamine (MEA, 0.4 M in 1 mL of water). A flow of 15% CO₂ concentration balanced by nitrogen was used.

FIGS. 7A-7D are related to cyclic stability of the electrochemical CO₂ capture and release by 1-AP nitrate (1) redox system for 5 cycles. As shown in FIG. 7A, a constant current of −50 mA was applied for 49.6 min (1.54 mmol of electrons) for cycle 1 and 41.4 min (1.29 mmol of electrons) for cycle 2 to 5 to reduce the amine (0.2 M, 0.8 mmol in 4 mL water), followed by bubbling of the solution with pure CO₂ for 12 min, and application of a constant current of 50 mA for the oxidation step for 44.1 min (1.37 mmol of electrons) for cycle 1 to 5. FIG. 7B shows CO₂ fraction. FIG. 7C shows gas output. FIG. 7D shows the amount of released CO₂.

FIGS. 8A-8C are related to direct air capture and stability test of 1-APyl radical 2 solution. FIG. 8A shows CO₂ released by electrochemical oxidation on application of a constant current of 50 mA to the 1-APyl radical 2 solution (0.2 M, 3.5 mL) that was bubbled with air for 18 h at a flow rate of ca. 100 mL/min. FIG. 8B shows CO₂ absorption profiles from air. 0.1, 0.2, and 0.4 M 1-APyl radical 2 aqueous solutions (1 mL) were bubbled with air at a flow rate of 3.3 mL/min at room temperature. FIG. 8C shows an oxygen sensitivity test. The 1-APyl radical 2 solutions (0.2 M, 5 mL) were bubbled with dioxygen for 1 and 30 days (curve shading matching the shading of the labels in the figure) at a flow rate of 10 mL/min followed by contact with pure CO₂ for an additional 12 min. The 1-APyl radical 2 solutions were sealed under nitrogen for 1 and 30 days followed by contact with pure CO₂ for 12 min for the control experiments. The solutions were electrochemically oxidized at a constant current of 50 mA and the released CO₂ was monitored.

### DETAILED DESCRIPTION

Methods and systems for electrochemically reacting (e.g., via a reduction reaction) an amine such that the amine becomes reactive with a target species (e.g., carbon dioxide) are provided. In some instances, electrochemical reaction of the amine induces one or more chemical reactions (e.g., redox and/or acid-base reactions) that results in the capture of the target species via formation of an adduct and/or via conversion of the target species into a different species (e.g., a less volatile species). In some instances, the combination of the amine and the target species is subsequently reacted (e.g., via an oxidation reaction) such that the target species is released from the amine. The methods and systems described in this disclosure may promote energetically efficient, reversible capture and release of target species. In some instances, the methods and systems described can employ aqueous solutions as opposed to more costly, toxic, and/or environmentally unfriendly substances such as room-temperature ionic liquids.

It can be desirable to capture and/or separate target species such as target gases from fluid mixtures. One example is carbon dioxide. Anthropogenic carbon dioxide (CO₂) emission from the combustion of fossil fuels is a major contributor to global climate change and ocean acidification. Implementation of carbon capture and storage technologies has been proposed to mitigate the build-up of this greenhouse gas in the atmosphere. Among these technologies, direct air capture is regarded as a plausible CO₂ removal tool whereby net negative emissions can be achieved. However, separation of CO₂ from air is particularly challenging due to the ultra-dilute concentration of CO₂ in the presence of high concentrations of dioxygen and water. Here, we report a robust electrochemical redox-active amine system demonstrating a high electron utilization (i.e., mole of CO₂ per mole of electrons) of up to 1.25 with the capture of two CO₂ molecules per amine in an aqueous solution with a work of 101 kJₑ per mole of CO₂. Capture of CO₂ directly from ambient air as the feed gas presented an electron utilization of 0.78.

Various embodiments are related to electrochemical processes for target species capture. For example, various embodiments are directed to capture of gaseous target species. Various embodiments are related to electrochemical processes for CO₂ capture. In some embodiments, the process involves direct air capture (DAC). In some embodiments, 1-aminopyridinium is employed. In some embodiments, high Faradaic efficiency is achieved.

It is essential that the accumulation of CO₂ in the atmosphere be constrained to slow global warming, as increasing ambient levels of this gas are recognized to be the primary factor behind undesirable climate pattern changes. Carbon capture and storage (CCS) technologies have received considerable attention from the scientific community for the effective minimization of CO₂ emissions to the environment, but more recently, direct air capture (DAC) has been given serious consideration as a “negative carbon emission” technology for the reduction of the atmospheric concentration of CO₂. While conventional CO₂ capture technologies generally target CO₂ concentrations in the range of 5 to 20% typical of emissions from stationary sources such as power plants and large industrial processes, CO₂ emissions from dispersed and mobile sources can be mitigated by capturing this greenhouse gas directly from the atmosphere, which currently contains about 412 parts per million (˜0.04%) of CO₂ in the presence of high concentrations of dioxygen (21%) and water (0.2-4%). Effective technologies for addressing the global climate change problem via DAC must, therefore, be stable towards these species to maintain high CO₂ capture performance.

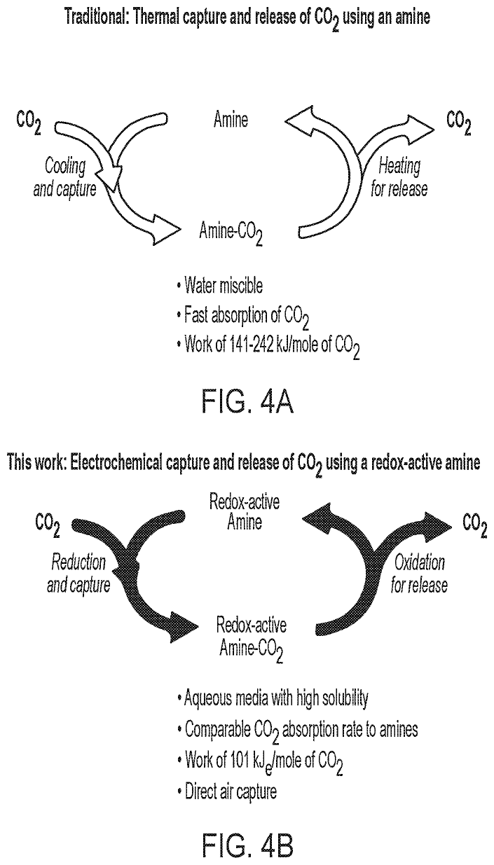

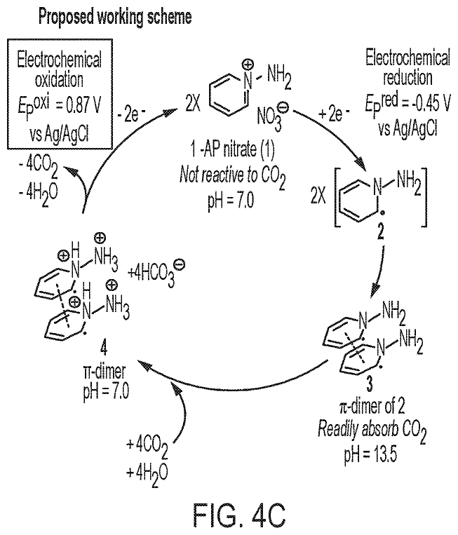

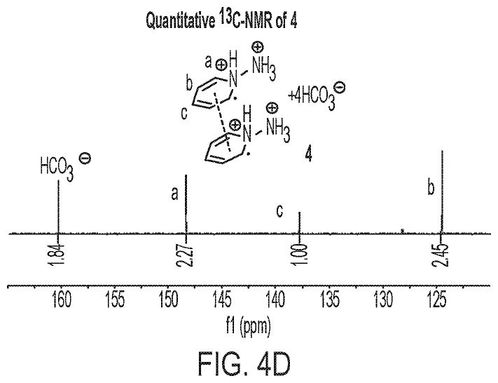

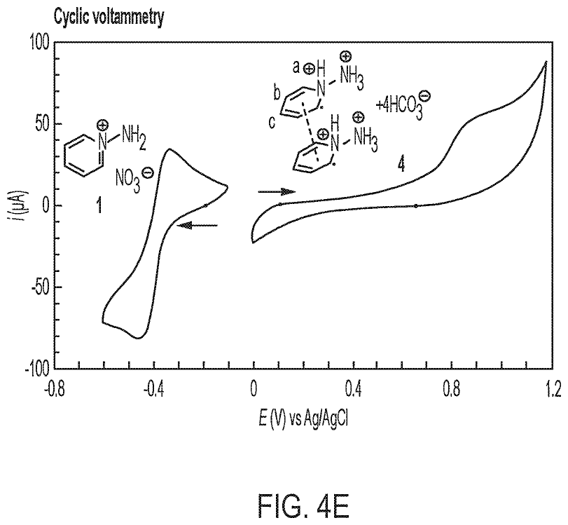

The most advanced technologies for CO₂ capture involve thermal cycles in which an aqueous alkanolamine absorbent, e.g., monoethanolamine (MEA), selectively captures CO₂ from impure gas streams, and this process is then followed by a thermal stripping operation in which pure CO₂ is released and the absorbent is regenerated (FIG. 4A). However, despite their widespread use, current thermal-based capture technologies face challenges, including high energy requirements.

Several electrochemical approaches for the capture and release of CO₂ as possible alternatives to the benchmark thermal amine capture processes have been explored using organic redox-active compounds such as quinone derivatives, bipyridine and disulfide, and electrochemically mediated amine regeneration (EMAR) methods employing a metal (e.g., copper) to displace the CO₂ from the amine. The major benefits of electrochemical methods over conventional thermal processes are the potentially lower energy consumption and the plug-and-play nature of their operation. However, disadvantages such as requiring pricey ionic liquid or volatile organic solvents, significant reactivities to dioxygen or water, and repetitive polarity switches (in the case of EMAR system) have prevented broader applications of electrochemical approaches to CO₂ mitigation. Furthermore, a limited number of studies of electrochemical capture and release of CO₂ from ultra-dilute CO₂ gas streams are available to date.

Therefore, there is a broad and urgent need for the development of efficient reversible electrochemical redox cycles that promote the capture of CO₂ from ultra-dilute gas streams, ideally, through direct air capture, and that operate under a wide range of dioxygen and humidity levels. Robust, stable, and electrochemically reversible redox cycles involving an organic radical are of great importance not only to CCS applications, but also to photochemistry, catalysis, synthesis, materials science, redox flow batteries, spintronics, and biology.

It has been realized in the context of this disclosure that certain amines, such as redox-active amines can be used for electrochemical treatment of target species (e.g., for capture). Stable pyridinyl radicals have been discovered, but have not been explored much as redox switches, in contrast to bipyridine, which has been one of the most popular redox switches in many areas of research. In 1998, Monk and Hodgkinson reported that the 1-aminopyridinium (1-AP) cation could generate a stable, uncharged, radical species under acidic conditions by electrochemical reduction. However, further electrochemical studies have not been carried out to any great extent. We hypothesized that electrochemical control of the nucleophilicity of the 1-AP cation and its 1-aminopyridinyl (1-APyl) radical in an aqueous solution should promote reversible electrochemical capture and release of CO₂.

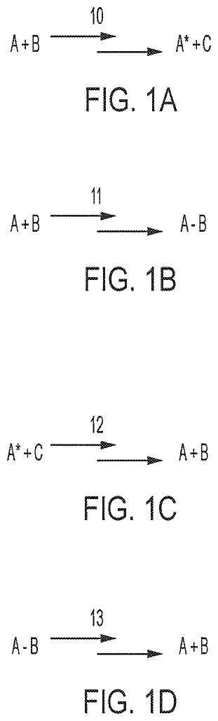

In some aspects, an amine is electrochemically reacted such that the amine becomes reactive with a target species. For example, referring to FIGS. 1A-1B, amine A may be electrochemically reacted via one or more electrochemically-induced reactions 10 (FIG. 1A) or 11 (FIG. 1B) such that amine A is reactive toward target species B (e.g., carbon dioxide or a different target species as described below).

In some embodiments, the step of electrochemically reacting the amine such that it becomes reactive with the target species is performed via a reduction reaction. The reduction reaction may involve transferring one or more electrons to the amine such that an amine species is formed having more electrons than the original amine subjected to the electrochemical reaction. For example, in some embodiments where the amine is 1-aminopyridinium, the step of electrochemically reacting the 1-aminopyridinium such that it is reactive toward the target species comprises reducing the 1-aminopyridinium such that the neutral 1-aminopyridinyl radical is formed, which has one more electron than 1-aminopyridinium. The 1-aminopyridinyl radical may be reactive with the target species.

In some embodiments, the step of electrochemically reacting the amine such that it is reactive with the target species is performed via an oxidation reaction. The oxidation reaction may involve removing one or more electrons from the amine such that an amine species is formed having fewer electrons than the original amine subjected to the electrochemical reaction.

In embodiments where the amine is electrochemically reduced or oxidized such that it becomes reactive with the target species, the reduction or oxidation may involve one or more electron transfer reactions, via outer sphere (electron/hole transfer) and/or inner sphere (bond breaking and/or bond making) mechanisms. In some embodiments, the step of electrochemically reacting the amine such that it is reactive with the target species involves forming a species in which the oxidation state of the nitrogen of the amine is changed (e.g., where an added electron or hole is primarily localized on the nitrogen of the amine). However, in some embodiments, the step of electrochemically reacting the amine such that it is reactive with the target species involves forming a species where the oxidation state of the nitrogen of the amine is unchanged. For example, in some embodiments where the amine comprises an organic moiety bonded to the nitrogen of the amine, an added electron or hole from the reduction or oxidation reaction is primarily localized on the organic moiety rather than the nitrogen of the amine.

In some embodiments where the amine is electrochemically reacted such that it becomes reactive with the target species, the amine directly interacts with an electrode (e.g., as part of an electrochemical cell). For example, in some such embodiments, the amine is close enough to the electrode (e.g., a solid electrode) such that an electron or hole transfers from the electrode to the amine without traveling via any intervening chemical species. For example, the amine may be immobilized with respect to the electrode (e.g., as part of an amine-functionalized electrode) or the amine may be a dissolved species that undergoes the electrochemical reaction by diffusing close enough to the electrode to undergo a direct reaction (e.g., electron transfer from the electrode).

In some embodiments where the amine is electrochemically reacted such that it becomes reactive with the target species, the amine indirectly interacts with an electrode. For example, in some embodiments, the amine undergoes an electrochemical reaction involving one or more redox mediators. For example, a redox mediator may be a species that can shuttle electrons from the electrode to the amine (e.g., an amine freely diffusing in solution).

As noted above, the amine may become reactive with the target species due to the electrochemical reaction. The amine may be reactive with the target species via any of a variety of mechanisms. For example, the amine in its state following the electrochemical reaction may be reactive with the target species because it can thermodynamically spontaneously initiate one or more chemical reactions that result in a chemical change to the target species under the conditions under which the method is being performed (e.g., at the temperature and pressure at which the method is being performed). For example, in some embodiments, the amine in its state following the electrochemical reaction is reactive with the target species in that it itself can thermodynamically spontaneously directly form a chemical bond (e.g., a covalent bond, an ionic bond, and/or a hydrogen bond) with the target species under the conditions under which the method is being performed (e.g., at the temperature and pressure at which the method is being performed). As one specific example, the amine may be electrochemically reduced to form a one-electron-reduced species, and that one-electron-reduced species may thermodynamically spontaneously form a chemical bond with the target species without undergoing any intermediates prior to direct reaction with the target species.

However, in some embodiments, one or more intermediate species are involved in the reactivity between the electrochemically-reacted amine and the target species. For example, the amine in its state following the electrochemical reaction may be reactive with the target species in that it can thermodynamically spontaneously form one or more intermediates, at least one of which can directly form a chemical bond with the target species. As yet another example, the amine in its state following the electrochemical reaction may be reactive with the target species in that it can thermodynamically spontaneously form one or more intermediates, at least one of which can undergo a reaction that causes a chemical change in the target species.

In some embodiments, the amine in its state following the electrochemical reaction is reactive with the target species in that it itself can undergo one or more acid-base reactions (e.g., a reaction involving one or more proton transfers) that causes a chemical change in the target species (e.g., involving protonation or deprotonation of the target species). In some embodiments, the amine in its state following the electrochemical reaction is reactive with the target species in that it can thermodynamically spontaneously form one or more intermediates, at least one of which can undergo one or more acid-base reactions (e.g., a reaction involving one or more proton transfers) that causes a chemical change in the target species (e.g., involving protonation or deprotonation of the target species). For example, in some embodiments where the target species comprises a Brønsted-Lowry acid or an anhydride of a Brønsted-Lowry acid, the amine becomes reactive with the target species at least in part due to having a pKₐ greater than or equal to a pKₐ of the Brønsted-Lowry acid following the electrochemically reacting step. In some such embodiments, the amine can therefore initiate one or more proton transfer reactions resulting in the amine gaining one or more protons and the Brønsted-Lowry acid losing one or more protons. Such reactivity may result in formation of a product from the target species that is less volatile than the target species.

As noted above, in some embodiments, the electrochemical reaction of the amine causes the amine to become reactive with the target species by causing a chemical change in the target species. For example, the chemical change in the target species may involve causing the target species to form one or more new chemical bonds and/or causing one or more chemical bonds in the target species to break. In some embodiments, the chemical change in the target species involves conversion of the target species from a species that is a gaseous species under the conditions of the method to a non-gaseous species. For example, in some embodiments where the target species is carbon dioxide (a gaseous species), the chemical change caused by the electrochemical reaction of the amine induces formation of bicarbonate anion (a non-gaseous species from the carbon dioxide).

In some embodiments, the amine is electrochemically reacted such that the target species is captured. For example, in some embodiments, the amine is reacted with the target species to capture the target species. In some embodiments, the method involves exposing an input fluid mixture comprising the target species (e.g., a gaseous mixture comprising gaseous target species) to the amine, and the resulting capture of the target species results in a reduction in the concentration of the target species in the fluid mixture (e.g., on a molar basis of at least 10%, at least 25%, at least 50%, at least 75%, at least 90%, at least 95%, at least 98%, at least 99%, at least 99.9%, at least 99.99% or more (e.g., 100%)). In some embodiments, the method involves exposing an input fluid mixture comprising the target species (e.g., a gaseous mixture comprising gaseous target species) to the amine, and the resulting capture of the target species results in a reduction in the concentration of the target species in the fluid mixture (e.g., on a molar basis of up to 75%, up to 90%, up to 95%, up to 98%, up to 99%, up to 99.9%, up to 99.99%, or more (e.g., 100%)). Combinations of these ranges are possible.

Any of the reactivities described above may be employed to capture the target species. For example, capture of the target species may involve direct reaction of the amine and the target species. For example, capture of the target species may involve direct bonding of the target species to the amine. In some embodiments, capture of the target species may involve indirect reaction of the amine and the target species. For example, capture of the target species may involve conversion of the amine into an intermediate species that directly reacts with the target species (e.g., via direct bonding of the target species to the intermediate). In some embodiments, capture of the target species involves conversion of the target species into a different species (e.g., conversion from a gaseous species such as carbon dioxide to a non-gaseous species such as bicarbonate anion).

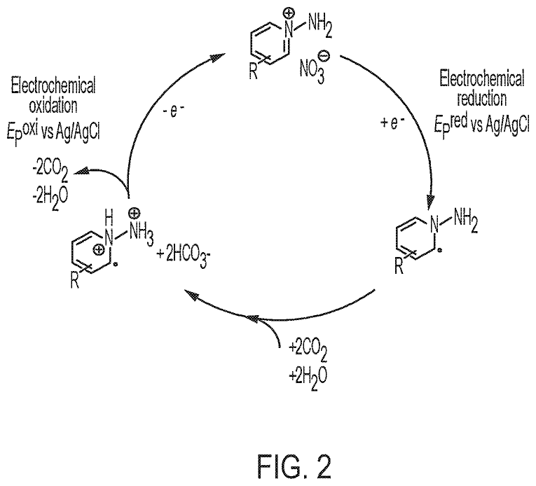

In some embodiments, reaction of the amine with the target species to capture the target species comprises one or more chemical reactions between the amine, the target species, and/or one or more reaction products formed by the target species. For example, referring again to FIG. 1A, amine A may undergo one or more electrochemically-induced reactions 10 resulting in capture of target species B by forming modified amine A* and new chemical species C (formed via a chemical change in target species B). In some embodiments, reaction of the amine with the target species to capture the target species comprises forming a Brønsted Lowry acid from the target species (e.g., by dissolving the target species in a water-containing solution). In some such embodiments, the method further comprises protonating the amine (e.g., due to an electrochemically-induced increase in the basicity of the amine such as via electrochemical reduction). In some such embodiments, the method comprises forming a conjugate base of the Brønsted Lowry acid (e.g., due to the formation of a sufficiently strong base such as hydroxide ions during the method). The example involving the electrochemical reduction of an amine (such as an optionally-substituted 1-aminopyridinium) to form a reduced amine (e.g., optionally-substituted 1-aminopyridinyl radical) which is then protonated thereby inducing conversion of carbon dioxide to bicarbonate is an example of this type of mechanism and is consistent with the reactivity shown in FIG. 1A. FIG. 2 illustrates one-limiting example of such a mechanism, where an optionally-substituted 1-aminopyridinium (top of reaction cycle) undergoes an electrochemical reduction to form an optionally-substituted 1-aminopyridinyl radical, while a target species in the form of carbon dioxide forms a Brønsted Lowry acid in the form of carbonic acid (H₂CO₃) upon dissolution (e.g., in an aqueous solution). Because the optionally-reduced 1-aminopyridinyl radical is a relatively strong base (and has a higher pKₐ than that of the carbonic acid), a series of acid-base reaction occurs resulting in the protonation of the optionally-reduced 1-aminopyridinyl radical and the deprotonation of the carbonic acid to form its conjugate base, bicarbonate anion (see left side of the cycle). At least because the bicarbonate anion is a stable, non-volatile species in the aqueous solution, the carbon dioxide is thereby considered captured. While this mechanism in FIG. 2 is shown with 1-aminopyridinium derivatives, it should be understood that other types of amines (e.g., 1-aminopyrazines and amino-phenazines) can undergo the same or similar mechanisms. And while this mechanism in FIG. 2 is shown with carbon dioxide as the target species, it should be understood that other types of target species that can form a Brønsted Lowry acid (e.g., upon dissolution in an aqueous solution) such as SOₓ species (e.g., SO₂, SO₃) and nitrogen oxides can undergo the same or similar mechanisms.

In some embodiments, electrochemically reacting the amine results in an increase in the pH of a solution in which the amine is present (e.g., by at least 0.01, at least 0.1, at least 0.2, at least 0.5, at least 1, at least 2, at least 3, at least 4, at least 5, or more pH units). The increase in pH of the solution (e.g., an aqueous solution) may be caused by an electrochemical reduction of the amine increasing the pKₐ of the amine, which can result in the reduced amine deprotonating acids in the solution. For example, the reduced amine may deprotonate water in an aqueous solution, thereby increasing the number of hydroxide ions present in the solution, which results in an increased pH of the solution. In some embodiments, the increase in the pH of the solution contributes to the capture of the target species.

In some embodiments, the amine reacts with the target species to capture the target species via direct chemical bond formation between the amine (or a modified version of the amine such as a protonated form of the amine) and the target species. For example, referring to FIG. 1B, amine A may undergo one or more electrochemically-induced reactions 11 resulting in capture of target species B by forming adduct A-B (e.g., via a covalent bond between amine A (e.g., at the nitrogen of the amine or elsewhere on amine A such as on a carbon) and target species B). One example of such chemistry is where the target species is carbon dioxide and the amine undergoes a chemical reaction (e.g., reduction) that results in the amine becoming a sufficiently strong nucleophile such that it can attack and form a chemical bond with the carbon dioxide (e.g., via formation of a carbamate group).

In some embodiments, the combination of the amine and the target species are reacted such that the target species is released from the amine. Such a reaction between the amine and the target species resulting in the release of the target species may be induced electrochemically and/or chemically (e.g., via use of one or more chemical reagents such as a chemical oxidant).

The combination of the amine and the target species need not necessarily be an adduct or complex between the amine and the target species. Rather, the combination generally refers to the collection of the amine and the target species whether they are immobilized with respect to each other or can freely diffuse from each other. The combination of the amine and the target species may be in the form of a modified version of the amine (e.g., a reduced and protonated amine) and a separate chemically-converted target species. For example, referring to FIG. 1C, combination of amine and target species A*+C may be reacted via one or more reactions 12 such that original amine A and original target species B from the scheme is FIG. 1A is formed, thereby releasing target species B. As one specific example, in some embodiments involving the optionally-substituted 1-aminopyridinium and carbon dioxide, the capturing process may involve formation of protonated 1-aminopyridinyl radical and bicarbonate anion (see left side of reaction cycle in FIG. 2). That combination of protonated 1-aminopyridinyl radical and bicarbonate may be reacted such that carbon dioxide is released. For example, electrochemical or chemical oxidation of the protonated 1-aminopyridinyl radical may induce one or more acid-base reactions (e.g., via one or more proton transfers) that shift the acid-base equilibrium between carbon dioxide, carbonic acid, and bicarbonate toward carbon dioxide.

In some embodiments, the combination of the amine and the target species is in the form of an adduct between the amine and the target species (e.g., due to direct chemical bond formation between the two). In some such embodiments, the adduct is reacted in such a way that it dissociates, thereby releasing the target species. For example, in FIG. 1D, combination of amine and target species in the form of adduct A-B undergoes one or more chemical reactions 13 such that original amine A and original target species B from FIG. 1B are formed. The adduct may be dissociated electrochemically or chemically (e.g., via an oxidation or reduction reaction that results in homolysis or heterolysis of a chemical bond between the amine and the target species).

In some embodiments, the step of reacting the combination of the amine and the target species is performed via an oxidation reaction. In some embodiments, the step of reacting the combination of the amine and the target species is performed via a reduction reaction. In some embodiments where the reaction of the combination of the amine and the target species is performed electrochemically, the combination of the amine and the target species directly interacts with an electrode (e.g., as part of an electrochemical cell). For example, in some such embodiments, at least a portion of the combination of the amine and the target species is close enough to the electrode (e.g., a solid electrode) such that an electron or hole transfers from the electrode to that portion without traveling via any intervening chemical species. For example, the amine may be immobilized with respect to the electrode (e.g., as part of an amine-functionalized electrode) or the amine may be a dissolved species that undergoes the electrochemical reaction by diffusing close enough to the electrode to undergo a direct reaction.

In some embodiments, the target species is released such that an output fluid mixture (e.g., gas stream) is formed comprising the target species in an amount of greater than or equal 0.000000001%, greater than or equal to 0.00000001%, greater than or equal to 0.000001%, greater than or equal to 0.00001%, greater than or equal to 0.0001%, greater than or equal to 0.001%, greater than or equal to 0.01%, greater than or equal to 0.1%, greater than or equal to 1%, greater than or equal to 5%, greater than or equal to 10%, greater than or equal to 25%, greater than or equal to 50%, and/or up to 75%, up to 90%, up to 95%, up to 98%, up to 99%, or greater (e.g., 100%) on a mass basis. Combinations of these ranges are possible.

Any of a variety of amines may be used in the methods and systems described in this disclosure, depending on the nature of the target species. In some embodiments, the amine is a redox-active amine. In some embodiments, the redox-active amine can undergo at least one reduction and/or oxidation reaction (e.g., an electrochemically-induced reduction or oxidation reaction) within at least one solvent window (e.g., within the solvent window of water or a different solvent such as an organic liquid-containing solvent). In some embodiments, the redox-active amine can undergo at least one reversible reduction and/or oxidation reaction (e.g., an electrochemically-induced reduction or oxidation reaction) within at least one solvent window. In some embodiments, the reduction and/or oxidation reaction involves an outer-sphere and/or an inner sphere electron transfer. As noted above, in some instances, the redox-activity of the amine is localized at the nitrogen in the amine, while in other embodiments the redox-activity of the amine is localized at a different portion of the amine (e.g., an organic moiety) or delocalized throughout a portion or all of the amine.

In some embodiments, the amine (e.g., a redox-active amine) has a standard reduction potential for undergoing the electrochemical reaction (e.g., electrochemical reduction) that results in it becoming reactive with the target species that is relatively positive. Such a relatively positive reduction potential may contribute to the methods of reacting target species described in this disclosure being performed with relatively high energy efficiencies. In some embodiments, the amine has a standard reduction potential for undergoing the electrochemical reaction (e.g., electrochemical reduction) that is equal to or more positive than −1.0 V, equal to or more positive than −0.8 V, equal to or more positive than −0.73 V, equal to or more positive than −0.6 V, equal to or more positive than −0.5 V, equal to or more positive than −0.45 V, equal to or more positive than −0.4 V, or greater vs. Ag⁺/AgCl under the conditions of the method (e.g., in an aqueous solution at 298 K). In some embodiments, the amine has a standard reduction potential for undergoing the electrochemical reaction (e.g., electrochemical reduction) that is equal to or more negative than 0 V, equal to or more negative than −0.1 V, equal to or more negative than −0.2 V, or less vs. Ag⁺/AgCl under the conditions of the method (e.g., in an aqueous solution at 298 K). Combinations of these ranges are possible.

In some embodiments, the electrochemical reaction of the amine can result in a species having an increased pKₐ. For example, in some embodiments, electrochemically reacting the amine (e.g., via a reduction reaction) increases the pKₐ of the amine (e.g., as measured in an aqueous solution) by at least 0.5, at least 1.0, at least 1.5, at least 2.0, at least 3.0, at least 5.0, and/or up to 6.0, up to 7.0, or more relative to the amine prior to the electrochemical reaction (e.g., reduction).

In some embodiments where the target species comprises a Brønsted-Lowry acid or an anhydride of a Brønsted-Lowry acid, the electrochemical reaction of the amine results in a species (e.g., a reduced amine) having a pKₐ (e.g., as measured in an aqueous solution) that is greater than that of the Brønsted-Lowry acid (e.g., by at least 0.5, at least 1.0, at least 1.5, at least 2.0, at least 3.0, at least 5.0, at least 6.0, at least 7.0, at least 8.0, at least 9.0, at least 10.0, and/or up to 11.0, up to 12.0, up to 13.0, up to 14.0, or more). For example, in some embodiments where the target species is carbon dioxide, the carbon dioxide dissolves in an aqueous solution and forms the Brønsted-Lowry acid carbonic acid, which has a pKₐ of approximately 6.8 in water. Accordingly, in some embodiments involving carbon dioxide as the target species, the electrochemical reaction of the amine results in a species (e.g., a reduced amine) having a pKₐ in water that is at least 7.3, at least 7.8, at least 8.3, at least 8.8, at least 9.8, at least 11.8, at least 12.8, at least 13.8, at least 14.8, at least 15.8, at least 16.8, and/or up to 17.8, up to 18.8, up to 19.8, up to 20.8, or more.

In some embodiments, the amine comprises at least one moiety that can stabilize electron density. For example, in some embodiments, the amine has a radical-stabilizing moiety. The presence of such a moiety may contribute to the redox-activity of the amine and/or the stability of a resulting reduced amine. Electron density and/or radicals may be stabilized via any of a variety of structures. For example, the amine may comprise one or more organic moieties known to stabilize radicals and/or negative charges. For example, the amine may comprise an organic moiety with a π-system, which can stabilize radicals and/or negative charge density via resonance/charge delocalization, and in some instances can contribute to the formation of a dimer (e.g., a π-dimer), which may also stabilize a reduced species (e.g., a radical-containing species). In some embodiments, the amine comprises an aromatic moiety, which can stabilize radicals and/or negative charge. In some embodiments, the amine comprises one or more electron-withdrawing groups, which may help stabilize negative charge.

In some embodiments, the amine that is electrochemically reacted is a cationic species. For example, in some embodiments the amine is an optionally-substituted 1-aminopyridinium, which carries a positive charge. Carrying an overall positive charge may promote the redox-activity of the amine and an overall energetically efficient process.

In some embodiments, the amine has a chemical structure of NR′₃, where each R′ can independently be hydrogen, branched or unbranched optionally-substituted C₁-C₁₈ alkyl, branched or unbranched optionally-substituted C₁-C₁₈ alkenyl, branched or unbranched optionally-substituted C₁-C₁₈ alkynyl, branched or unbranched optionally-substituted C₁-C₁₈ heteroalkyl, branched or unbranched optionally-substituted C₁-C₁₈ heteroalkenyl, branched or unbranched optionally-substituted C₁-Cis heteroalkynyl, optionally-substituted cyclyl, optionally-substituted heterocyclyl, optionally-substituted aromatic, optionally-substituted heteroaromatic, amino, amido, and/or imido. In some embodiments, the amine is part of and/or appended to an aromatic moiety (e.g., aryl, benzyl) and/or a heteroaromatic group (e.g., pyridyl, pyrazyl, phenazyl, quinolyl, bipyridyl). In some embodiments, the amine comprises an N—N bond. For example, the amine may comprise a covalent bond between a first nitrogen (e.g., the nitrogen of an amino group) and a second nitrogen, where the second nitrogen is part of a heteroaromatic group.

In some embodiments, the amine comprises a pyridinium group. For example, in some embodiments, the amine comprises an optionally-substituted 1-aminopyridinium species. The optionally-substituted 1-aminopyridinium species may have a chemical structure as follows:

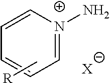

where X is a counteranion (e.g., nitrate, tetrafluoroborate, perchlorate) and there can be from 0 to 5 R groups. It should be understood that the counteranion is shown for charge balance and that in some embodiments the amine itself and the counteranion (e.g., X⁻) are not bound or otherwise associated with each other (e.g., the amine and the counteranion may be dissolved species solvated in a liquid solvent). In some embodiments, the R groups can independently be an optionally-substituted alkyl group (e.g., methyl, ethyl, propyl, t-butyl), an optionally-substituted heteroalkyl group, a carboxylic acid/carboxylate group (e.g., acetyl), an amino group (e.g., primary, secondary, or tertiary), an ether group (e.g., methoxy), hydroxy, cyclyl, heterocyclyl, a halo group (e.g., chloro, fluoro, bromo, iodo), thio, or sulfato. In some embodiments, the amine is or comprises 1-aminopyridinium.

In some embodiments, the amine comprises a pyrazinium group. For example, in some embodiments, the amine comprises an optionally-substituted 1-aminopyrazinium species. In some embodiments, the amine comprises a phenazinium group. For example, in some embodiments, the amine comprises an optionally-substituted amino-phenazinium species. In some embodiments, the amine comprises a viologen group.

In some embodiments, the amine is part of an oligomeric or a polymeric species (e.g., as part of a backbone or a side-chain residue of the oligomer or polymer). For example, the amine may be part of a redox-active oligomer or polymer.

In some embodiments, the amine is dissolved and/or suspended in a liquid solution during at least a portion of the method. Use of a dissolved amine may allow the amine to flow from a first electrode (e.g., where it can undergo a first electrochemical reaction such as a reduction) and then be transported to different location. For example, the electrochemically-reacted amine can be transported (e.g., via diffusion or directed flowing) to a second, different electrode where it can undergo a second, different electrochemical reaction such as an electrochemical oxidation (e.g., to release a captured target species), in accordance with some embodiments. Such a configuration may facilitate a continuous flow system (e.g., as opposed to a system requiring cycling for capture and release of target species). In some embodiments, the liquid solution in which the amine is dissolved and/or suspended is an aqueous solution. The aqueous solution may comprise water in an amount of at least 50 weight percent (wt %), at least 75 wt %, at least 90 wt %, at least 95 wt %, at least 98 wt %, at least 99 wt %, at least 99.9 wt %, or more (or 100 wt %) by the total weight of liquid in the liquid solution. In some embodiments, the aqueous solution has a pH of greater than or equal to 6, greater than or equal to 6.5, greater than or equal to 7, and/or less than or equal to 10, less than or equal to 9, less than or equal to 8, less than or equal to 7.5, or less. Combinations of these ranges are possible. In some embodiments, the aqueous solution has a pH of greater than or equal to 6, greater than or equal to 6.5, greater than or equal to 7, and/or less than or equal to 10, less than or equal to 9, less than or equal to 8, less than or equal to 7.5, or less prior to the step of electrochemically reacting the amine. In some embodiments, the aqueous solution is unbuffered or has a concentration of buffer than is less than that of the amine.

In some embodiments, the electrochemically-reacted amine (e.g., reduced amine) is stable in the aqueous solution (e.g., has a half-life of greater than or equal to 1 minute, greater than or equal to 1 hour, greater than or equal to 12 hours, greater than or equal to 1 day, greater than or equal to one week, greater than or equal to 1 month, and/or up to 2 months, up to 5 months, or greater). In some embodiments, the combination of the amine and the target species following their reaction discussed above is stable in the aqueous solution (e.g., has a lifetime of greater than or equal to 1 minute, greater than or equal to 1 hour, greater than or equal to 12 hours, greater than or equal to 1 day, greater than or equal to one week, and/or up to 1 month, up to 2 months, or greater).

In some embodiments, the liquid solution comprises a non-water liquid such as an organic liquid (e.g., an alcohol such as methanol or ethanol, N,N-dimethylformamide, acetonitrile, dimethylsulfoxide, an organic carbonate).

Any of a variety of target species may be used in the methods and systems described. In some embodiments the target species comprises a gaseous species under the conditions of the method. For example, in some embodiments the target species comprises species that is a gaseous species at 298 K and 1 atm. It should be understood that while in some instances the target species comprises a gaseous species, the gaseous species may be dissolved (e.g., a dissolved gas) during at least a portion of the method. For example, in some embodiments in which the target species is carbon dioxide, a gaseous stream of carbon dioxide may be bubbled into a liquid solution (e.g., an aqueous liquid solution) comprising dissolved amine, and a portion of the bubbled carbon dioxide may dissolve in the liquid solution and encounter the amine (e.g., for capture).

In some embodiments, the target species comprises a Lewis acid. In some embodiments, the target species comprises a Lewis acid gas. In some embodiments, the target species comprises an aprotic acid gas. In some embodiments, the target species comprises carbon dioxide. In some embodiments, the target species comprises a Brønsted-Lowry acid or an anhydride of a Brønsted-Lowry acid. A Brønsted-Lowry acid refers to any species that can donate a proton (H⁺) to another species. Examples of anhydrides of Brønsted-Lowry acids include carbon dioxide (which can form the Brønsted-Lowry acid carbonic acid upon addition of water), sulfur dioxide (which can form the Brønsted-Lowry acid sulfurous acid upon addition of water), sulfur trioxide (which can form the Brønsted-Lowry acid sulfuric acid upon addition of water), and N₂O₅ (which can form the Brønsted-Lowry acid nitric acid upon addition of water). In some embodiments, the target species comprises a sulfur-containing species (e.g., a gaseous sulfur oxide species). In some embodiments, the target species comprises a nitrogen-containing species (e.g., a gaseous nitrogen oxide species). In some embodiments, the target species comprises one or more boranes (e.g., BH₃)

The methods described in this disclosure can be performed using any of a variety of systems. In some embodiments, the system comprises an electrode. The electrode may be in electronic communication with the amine, as described in more detail below. The system may further comprise an inlet configured to be in fluidic communication with a source of a target species. The system may be configured to expose the target species to the amine.

The electrode may be part of an electrochemical cell. The electrochemical cell may be an apparatus in which redox half reactions take place at negative and positive electrodes.

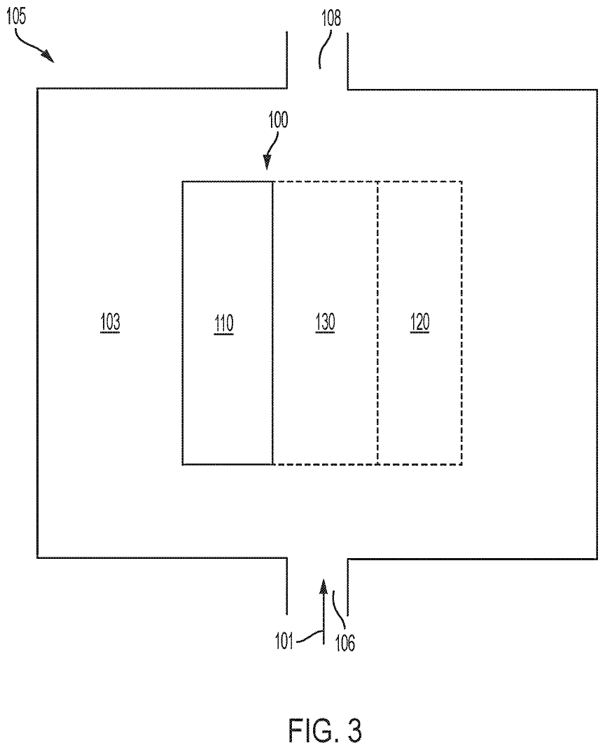

In some embodiments, the electrode is associated with a chamber. For example, FIG. 3 shows a cross-sectional schematic diagram of system 105 comprising chamber 103 and electrochemical cell 100, which may, in some instances, be configured to perform the methods described herein. System 105 in FIG. 3 comprises chamber 103 comprising inlet 106 and outlet 108. As such, one or more of the methods described herein may be performed by flowing fluid mixture 101 (e.g., comprising a target species) into chamber 103 via inlet 106, thereby exposing at least a portion of fluid mixture 101 to electrochemical cell 100 (e.g., including negative electrode 110). The electrochemical cell may be equipped with external circuitry and a power source (e.g., coupled to a potentiostat) to allow for application of the potential difference across electrodes. The system may be configured such that at least a portion of the fluid mixture can be transported out of the chamber via an outlet (e.g., outlet 108 in FIG. 3). In some embodiments, the inlet is fluidically connected to a source of the target species (e.g., a source of a fluid mixture comprising the target species such as ambient air or industrial effluent). In some embodiments, the outlet is fluidically connected to a downstream apparatus for further processing (e.g., another system for removing a more of the target species or a different target species). In some embodiments, the system comprises a plurality of the chambers (e.g., each comprising an electrode, at least some of which are in electronic communication with an amine) fluidically connected in series and/or in parallel. It should be understood that FIG. 3 shows a non-limiting embodiment, and one or more components (e.g., a chamber, a fluid outlet) shown in FIG. 3 may be optional in at least some embodiments.

As mentioned above, in some embodiments, the system comprises the amine in electronic communication with the electrode. For example, referring again to FIG. 3, in some embodiments, the amine (not pictured) is in electronic communication with electrode 110. Electronic communication in this context generally refers to an ability to undergo electron transfer reactions, either via outer sphere (electron/hole transfer) or inner sphere (bond breaking and/or bond making) mechanisms. In some embodiments in which the amine is in electronic communication with the electrode, the amine is immobilized on the electrode. For example, the amine may be part of a redox-active polymer immobilized on to the electrode via, in some instances, a composite layer (e.g., comprising a carbonaceous material such as carbon nanotubes). In some embodiments in which the amine is in electronic communication with the electrode, the amine is present in a conductive medium (e.g., a liquid solution such as an aqueous solution) in at least a portion of the electrochemical cell, and can undergo electron transfer reactions with the electrode (directly or indirectly). For example, the amine may be present (e.g., dissolved or suspended) in a liquid (e.g., a liquid electrolyte) of the electrochemical cell and be able to diffuse close enough to the electrode such that an electron transfer reaction can occur (e.g., to reduce the amine into at least one reduced state) upon application of the potential difference across the electrochemical cell.

As mentioned above, in some embodiments, the amine is immobilized on the electrode. Such embodiments may be distinguished from those of other embodiments, in which the amine is free to be transported from one electrode to another via, for example, advection. A species immobilized on an electrode (e.g., the negative electrode) may be one that, under a given set of conditions, is not capable of freely diffusing away from or dissociating from the electrode. The amine can be immobilized on an electrode in a variety of ways. For example, in some cases, an amine can be immobilized on an electrode by being bound (e.g., via covalent bonds, ionic bonds, and/or intramolecular interaction such as electrostatic forces, van der Waals forces, hydrogen bonding, etc.) to a surface of the electrode or a species or material attached to the electrode. In some embodiments, the amine can be immobilized on an electrode by being adsorbed onto the electrode. In some cases, the amine can be immobilized on an electrode by being polymerized onto the electrode. In certain cases, the amine can be immobilized on an electrode by being included in a composition (e.g., a coating, a composite layer, etc.) that is applied or deposited onto the electrode. In certain cases, the amine (e.g., polymeric or molecular amine) infiltrates a microfiber or, nanofiber, or carbon nanotube mat, such that the amine is immobilized with respect to the mat. The mat may provide a surface area enhancement for electrolyte and gas access, as well as expanded network for electrical conductivity. In some embodiments, the amine is part of a gel composition associated with the electrode (e.g., as a layer deposited on the electrode, as a composition infiltrating pores of the electrode, or as a composition at least partially encapsulating components of the electrode such as fibers or nanotubes of the electrode). Such a gel comprising the amine (e.g., a hydrogel, ionogel, organogel, etc.) may be prepared prior to association with the electrode (e.g., applied as a coating to form a layer), or the gel may be prepared in the presence of the electrode by contacting the electrode (e.g., via coating or submersion) with a gel precursor (e.g., a pre-polymer solution comprising the electroactive species) and gel formation may then be initiated (e.g., via cross-linking via introduction of a crosslinking agent, a radical initiator, heating, and/or irradiation with electromagnetic radiation (e.g., ultraviolet radiation)).

In some embodiments, the electrochemical cell of the system further comprises a positive electrode. In some, but not necessarily all embodiments, the electrochemical cell comprises a separator between the negative electrode and the positive electrode. For example, referring to FIG. 3, in some embodiments, electrochemical cell 100 comprises separator 130 between negative electrode 110 and positive electrode 120. As used herein, a negative electrode of an electrochemical cell refers to an electrode into which electrons are injected during a charging process and a positive electrode of an electrochemical cell refers to an electrode from which electrons are removed during a charging process. For example, referring again to FIG. 3, when electrochemical cell 100 is charged to perform an energetically uphill electrochemical reaction (e.g., via the application of a potential by an external power source), electrons pass from positive electrode 120, into an external circuit (not shown), and into negative electrode 110. As such, in some cases, species associated with the positive electrode, if present, can be oxidized to an oxidized state (a state having a decreased number of electrons) during a charging process of the electrochemical cell.

In some embodiments, the system is configured to electrochemically target species (e.g., carbon dioxide) from liquid mixtures. In some such instances, the system comprises a chamber able to be at least partially filled with a solution. In certain instances, the system, including the chamber and the electrochemical cell, is configured like that of a redox flow battery, wherein one of the flowed liquid solutions (e.g., comprising the target species and in some instances the amine) enters via the inlet of the chamber and exits via the outlet during operation. In certain embodiments, a portion of the chamber in fluidic contact with the electrode is fluidically connected to an absorbent material. As one non-limiting example, the chamber may be fluidically connected to an absorber tower. However, in some embodiments, the system is configured such that the target species is captured directly at the electrode (e.g., by binding with the amine during and/or after the application of the potential difference).

As mentioned above, in some embodiments, the inlet of the system can be configured to be in fluidic communication with a source of the target species. As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other. As used herein, two elements are fluidically connected to each other when they are connected such that, under at least one configuration of the elements and any intervening elements, the two elements are in fluidic communication with each other. Elements that are in fluidic communication with each other are always fluidically connected to each other, but not all elements that are fluidically connected to each other are necessarily in fluidic communication with each other.

U.S. Provisional Patent Application No. 63/214,845, filed Jun. 25, 2021, and entitled “Electrochemical Carbon Dioxide Capture and Release with a Redox-Active Amine” is incorporated herein by reference in its entirety for all purposes.

### Example 1

This example describes experiments related to one non-limiting example of methods and systems related to the electrochemical capture of a target species using an amine. Here, we report a unique and robust electrochemical capture and release of CO₂ employing 1-AP nitrate as a redox-active amine absorbent in an aqueous solution (FIG. 4B). This reversible electrochemical redox-active amine cycle was demonstrated to show CO₂ capture and release with electron utilization (i.e., mole of CO₂ per mole of electrons) during CO₂ release of up to 1.25 over a wide range of CO₂ concentrations, and, in particular, from ambient air. High aqueous solubilities (up to 13.3 M) of 1-AP nitrate should allow a large cyclic capacity for CO₂.

The prospective working scheme for electrochemical capture and release of CO₂ using 1-AP nitrate as a redox-active amine is depicted in FIG. 4C. The reducible precursor, 1-AP nitrate (1), which is not reactive to CO₂ in the neutral pH aqueous solution due to the positive charge in the pyridinium ring, can be reduced electrochemically by one-electron transfer to provide a room-temperature electron-rich 1-APyl radical 2. The 1-APyl radical 2, stabilized by the formation of a diamagnetic π-dimer 3 is nucleophilic to CO₂ under ambient CO₂ pressure. As CO₂ is introduced, the 1-APyl radical π-dimer 3 solution captures CO₂ to produce two bicarbonate molecules per 1-APyl radical 2, which mechanism is supported by the quantitative 13C-NMR spectrum (FIG. 4D). Then, the 1-APyl-bicarbonate 4 solution can be oxidized electrochemically to reproduce 1-AP nitrate (1) and release free CO₂ to close the redox-cycle. Isolation of the activated compounds 2, 3 and 4 was not successful and led to rapid decomposition to provide 4,4′-bipyridine.

Cyclic voltammetry (CV) was conducted to probe the mechanism of this process as depicted in FIG. 4E. One electron reduction of 1-AP nitrate (1, left curve) in water at a concentration of 20 mM under a nitrogen atmosphere shows a quasi-reversible wave with a reductive peak potential at −0.45 V vs. Ag/AgCl and an oxidative peak potential at −0.32 V vs. Ag/AgCl, which indicates that the 1-APyl radical 2 is stable in water at room temperature. The electrochemical reversibility of the 1-AP cation strongly suggests that a radical pathway is operative in the capture and release of CO₂ by the 1-AP redox cycle. The one-electron oxidation of the 1-APyl-bicarbonate 4 solution (right curve) represents an irreversible anodic peak at 0.87 V vs. Ag/AgCl, which is consistent with our proposed mechanism of immediate CO₂ release when 1-APyl-bicarbonate 4 is oxidized. Notably, neither disproportionation nor reduction of CO₂ by the 1-APyl radical was observed under the current conditions.

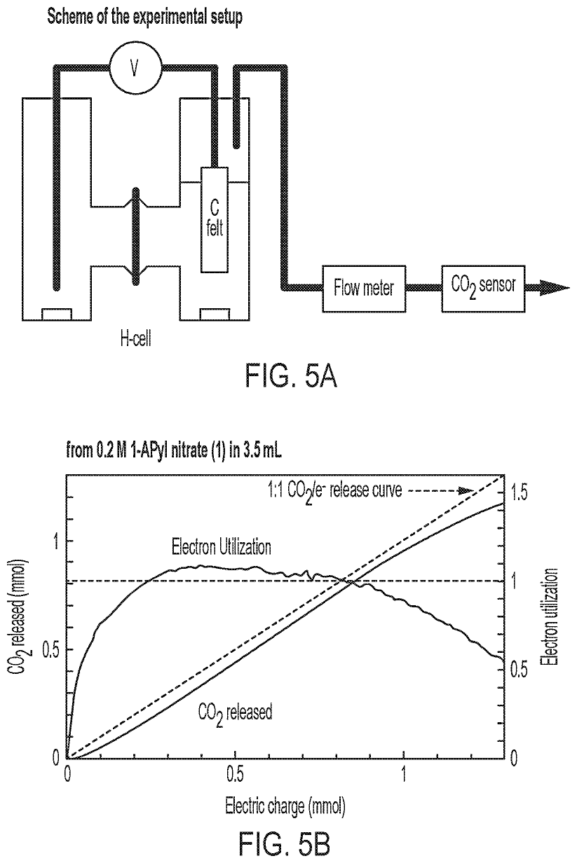

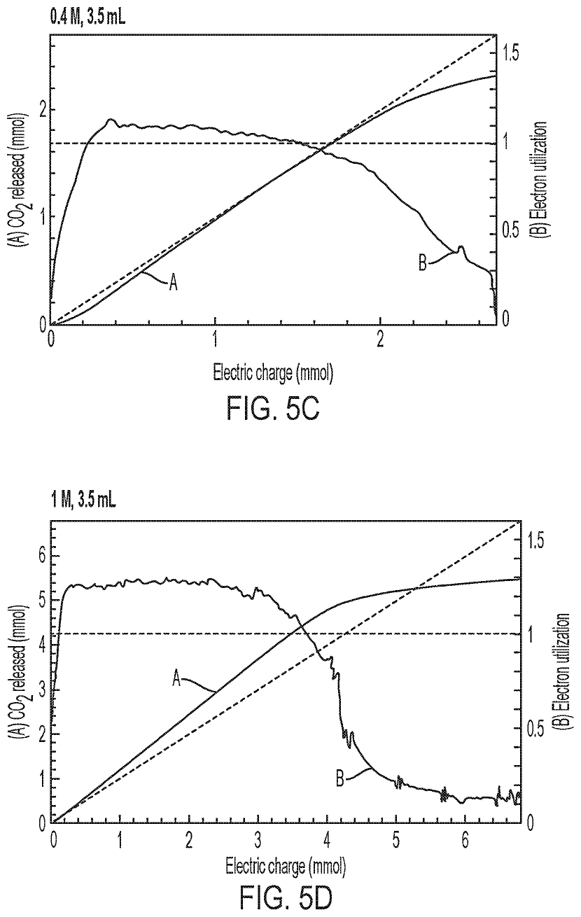

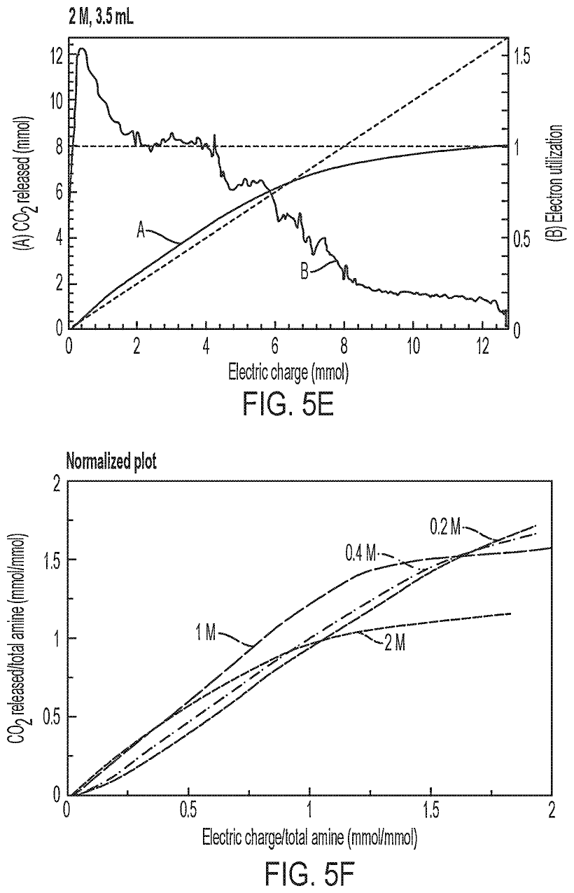

A bench-scale setup using an electrochemical H-cell was constructed and tested for the capture and release of CO₂ (FIG. 5A). The system was equipped with an anion exchange membrane separating two 5 mL reaction chambers, carbon felt as a working electrode, and a stainless steel wire electrode for an arbitrary reaction in the counter chamber. The reaction mixture containing 0.2 M of 1-AP nitrate (1, 1 mmol) in water (5 mL) in the presence of 1 M potassium nitrate as a supporting electrolyte was reduced by a constant current of 50 mA for 62 min (equal to 1.9 mmol of electrons) to provide the full conversion of the starting material to its radical with 53% Faradaic efficiency. Then, pure CO₂ was bubbled into the solution for 10 min to complete the saturation of the electrochemically generated 1-Apyl radical dimer 3 solution. The output gas flow from the resulting 1-APyl-bicarbonate 4 solution (3.5 mL) upon anodic oxidation was quantified and qualified by a CO₂ flow meter and an FT-IR CO₂ sensor, respectively. The electron utilization (ε_{CO}_{₂}) during CO₂ release on oxidation represents the ratio between the moles of CO₂ released and the moles of electrons transferred (equation 1):

$${ε}_{{CO}_{2}} = \frac{{n}_{C O 2}}{{n}_{e l e c t r o n s}} \qquad ( 1 )$$

Plots of the amount of released CO₂ by electrochemical oxidation versus electric charge in 1-APyl-bicarbonate 4 solutions prepared from 0.2, 0.4, 1, and 2 M 1-AP nitrate (1) solutions are displayed in FIGS. 5B-5E. The experimental CO₂ output from the 0.2 M solution showed a steeper slope than the 1:1 CO₂:electron capture curve, corresponding to an electron utilization of up to 1.08 (FIG. 5B). Although higher concentration solutions provided steeper slopes at the beginning of the process, the output CO₂ flow rate decreased rather rapidly as the reaction proceeded (FIGS. 5C-5E). Satisfactorily, a stable electron utilization of 1.25 was observed with the 1 M 1-AP nitrate (1) solution under the current conditions (FIG. 5D). FIG. 5F summarizes and compares the results for the different concentration solutions in terms of moles of CO₂ released per electric charge transferred, both normalized by the moles of amine in solution. It is clear that at higher amine concentrations there is a more sluggish release of CO₂ during the later stages of the oxidation process, which may be related to pH swing effects. Combining the voltage difference between the peak potentials from the CV measurements with the electrochemical electron utilization during CO₂ release, we estimated that the minimum system energy requirement with full utilization of the amine capacity would be 101 kJₑ per mole of CO₂. This energy demand can be reduced significantly to bring it in line with the 40-80 KJ/mol (˜140-240 KJ/mol thermal) required for the benchmark MEA process³¹ by only partially regenerating the amines to give a working capacity that is less (e.g., ˜50%) than the total capacity. The solutions of 1-AP cation with different counter anions such as perchlorate and tetrafluoroborate provided comparable CO₂ output results. We chose the nitrate salt to further evaluate the system due to its better electron utilization during CO₂ release as well as better conductivity in an aqueous solution.

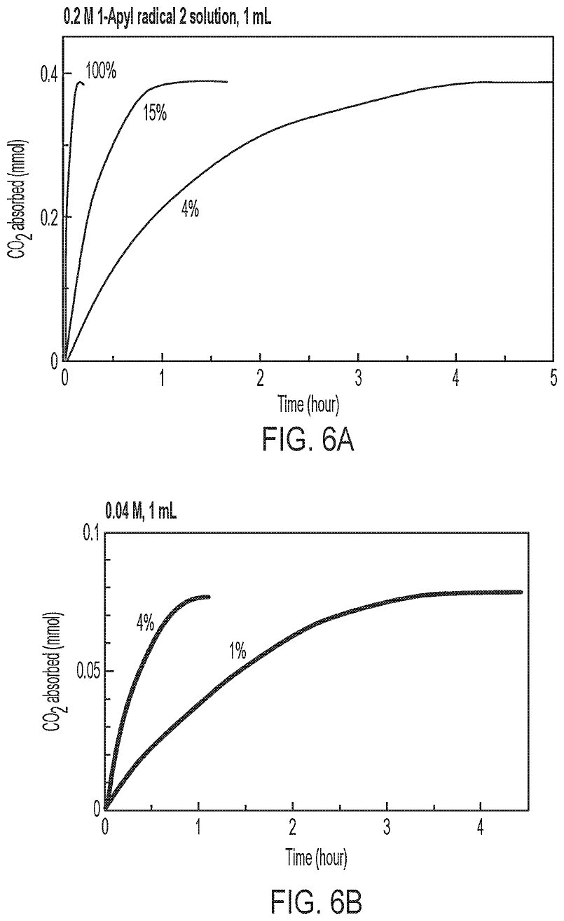

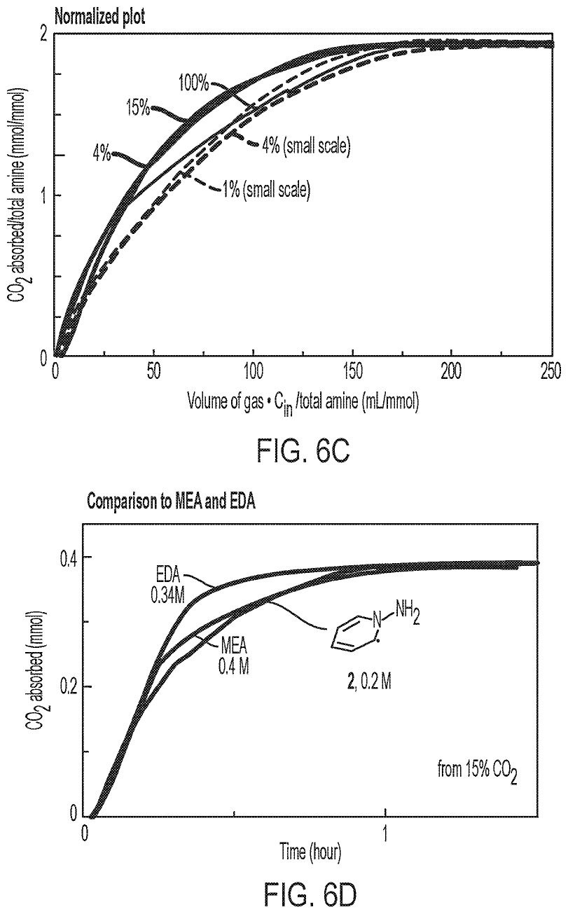

The CO₂ absorption dynamics under different conditions are displayed in FIGS. 6A-6D. The changes in flow rate and concentration of CO₂ were monitored by a CO₂ flow meter and an FT-IR CO₂ sensor, respectively. The 1 mL 1-APyl radical 2 solution prepared from 0.2 M 1-AP nitrate (1) solution was equilibrated with 4, 15, and 100% CO₂ inlet gas streams (balanced by nitrogen) and showed a constant capacity regardless of the concentration of CO₂ (FIG. 6A). In smaller-scale CO₂ absorption experiments using 1 mL of the 0.04 M solution (FIG. 6B), the same equilibrium CO₂ capacity was attained within a reasonable equilibration time for both the 1% and the 4% CO₂ inlet streams (FIG. 6B). In FIG. 6C, the CO₂ absorption curves for the 1, 4, 15, and 100% CO₂ inlet gas streams superimpose to show a constant capacity of 1.94 mole of CO₂ per mole of amine, with similar equilibration dynamics in terms of the volume of CO₂ introduced to the cell (mL) normalized by the total amine amount (mmol), which indicates a consistent behavior for CO₂ capture regardless of the feed CO₂ concentration over the range of 1 to 100% (FIG. 6C). Notably, the 1-APyl radical 2 solution showed a CO₂ absorption rate comparable to that of ethylenediamine (EDA) and monoethanolamine (MEA), commonly used amines in thermal processes (FIG. 6D). The capacity of the electrochemical CO₂ release process is 12.4 mmol/g of 1-AP nitrate. For comparison, the aqueous amine industrial capture process has an uptake efficiency of ca. 8 mmol/g.

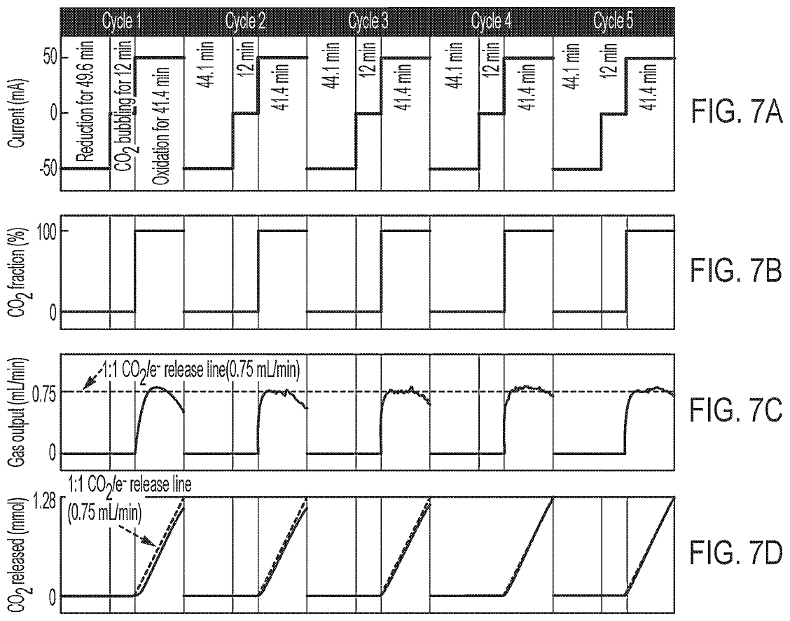

The reversible capture and release of CO₂ was tested over five cycles to evaluate the robustness of the 1-AP nitrate redox cycle (FIG. 7A-7D). The cyclic stability was evaluated with a 0.8 mmol amine solution and restricted to operate at 80% of the full capacity of the cell in order to minimize undesired side reactions. The gas output and CO₂ fraction were monitored to show reproducible and stable capture and release of CO₂ during five cycles under the applied current conditions. The gas release rate was steady at 0.75 mL/min, consistent with the release of one mole of CO₂ per mole electrons transferred under steady current flow in each cycle.

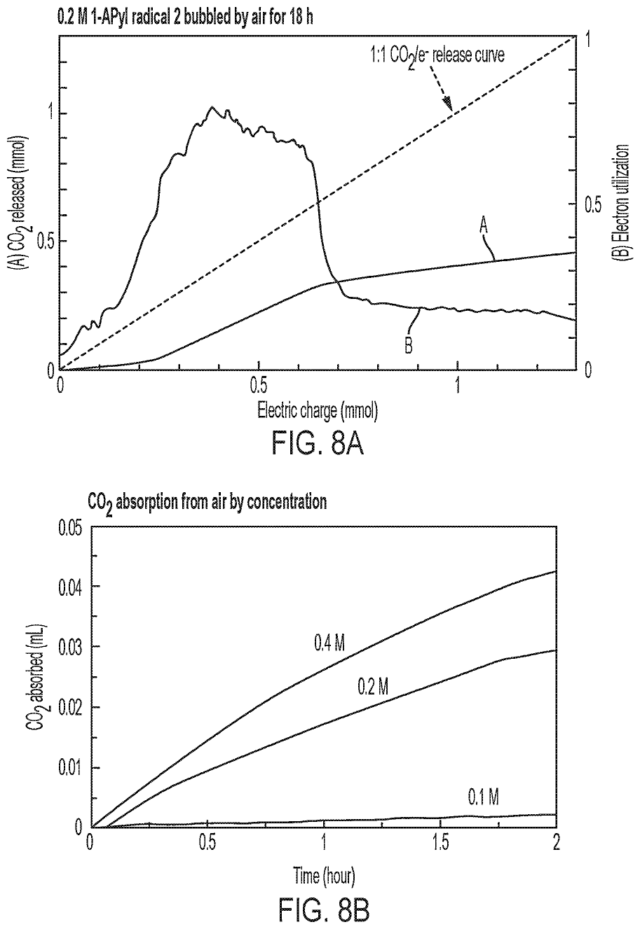

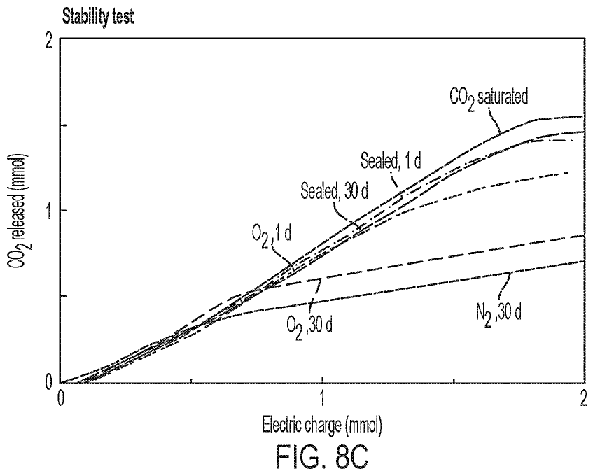

We next sought to expand the use of the 1-AP nitrate redox cycle to the direct capture of CO₂ from ambient air (FIGS. 8A-8C). The 1-APyl radical dimer 3 solution (3.5 mL) was prepared by first reducing a 0.2 M 1-AP nitrate (1) solution, and then bubbling the solution with non-pretreated air for 18 h at a flow rate of ca. 100 mL/min (FIG. 8A). Electrochemical oxidation of the air-bubbled solution was carried out to evaluate the direct air capture efficiency. The system presented electron utilization during CO₂ release of up to 0.78 with 36% cell capacity usage with the 0.2 M solution. Bubbling with air for an extended period of 4 days did not improve the results, indicating that the solutions were saturated. Initial CO₂ absorption rates from the ambient air were measured in 0.1, 0.2, and 0.4 M solutions of 1-APyl radical 2 (FIG. 8B). The CO₂ absorption rate from the air was significantly lower in the 0.1 M solution than in the others, consistent with the incomplete saturation of the 1-APyl solutions despite a longer air contact time. Considering the electron utilization during CO₂ release and the potential difference obtained from the CV, direct air capture under the current conditions requires as little as 162 kJₑ per mole of CO₂, which is within range of 400 KJ/mol thermal, considered a target to be achieved by DAC technologies.

To test the stability of the 1-APyl radical in air, a set of experiments was carried out (FIG. 8C). Exposure to pure dioxygen (10 mL/min) of the 1-APyl radical 2 solution (0.2 M, 5 mL) for 1 and 30 days (see corresponding curve in FIG. 8C) followed by saturation with pure CO₂ provided 6.6% and 46% decrease, respectively, of the capacity of the system compared to the output for the freshly CO₂-saturated solution (see corresponding curve in FIG. 8C). First control experiments conducted with the 1-APyl radical 2 solution (0.2 M, 5 mL) sealed under nitrogen and stored on the bench for 1 and 30 days (see corresponding curves in FIG. 8C), followed by bubbling with pure CO₂, resulted in 7.2% and 22% decrease, respectively, in the capacity of the system. These results suggest that the 1-APyl radical 2 might decompose slowly over time and the exposure to dioxygen could accelerate decomposition under the applied current conditions. A second control experiment conducted with the 1-APyl radical 2 solution (0.2 M, 5 mL) bubbled with nitrogen (10 mL/min) for 30 days showed a 54% decrease in the capacity, which indicates that gas bubbling could lead to decomposition of the activated compound to 4,4′-bipyridine that was observed as a byproduct. Although further studies for the stability under the various conditions are warranted, operation in the presence of oxygen remains feasible.

In conclusion, we demonstrated that the 1-AP nitrate redox cycle in an aqueous solution can be exploited for reversible electrochemical capture and release of CO₂ with electron utilization during CO₂ release of up to 1.25. The 1-APyl radical solution exhibits a constant capacity for capture of CO₂ from inlet streams of concentration from 1% to 100%. The robustness of this system, demonstrated for 5 cycles with no significant loss in performance, coupled with the stability of the 1-APyl radical to dioxygen, augurs well for its application in direct air capture operations. While we anticipate that the 1-AP cation redox cycle will introduce new opportunities for CO₂ separation from air, this cycle can also be used effectively in large-scale separations applications to avoid the need for thermal regeneration of the amine solutions. Moreover, in contrast to other indirect electrochemically mediated sorbent regeneration systems in which protons or metal ions released from an activated anode modulate the CO₂ binding to the sorbent, and which by their very nature necessitate cyclic operations, this direct redox couple facilitates continuous, stable operational opportunities. Process optimization and chemical modification of the 1-AP through the attachment of appropriate moieties that control the electron distribution, and hence the redox potentials, should lead to decreased energy expenditures, and to a viable process for CO₂ capture from a wide range of sources using electricity from renewable resources.

### Example 2

This example describes experiments involving additional non-limiting examples of methods and systems related to the electrochemical capture of a target species using an amine. More specifically, various additional amines were evaluated for efficacy in electrochemically capturing and in at least some instances releasing carbon dioxide. The additional amines included derivatives of 1-aminopyridinium with various counterions, as well as 1-aminopyrazinium and an amino-phenazinium.

The 1-aminopyridinium derivatives had the following general chemical structure (where X⁻ is a counteranion) with various R groups as delineated in the structures and in Table 1 below.

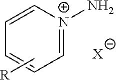

The structures of the 1-aminopyrzazinium and the amino-phenazinium are also shown below. The number to the left of each structure corresponds to its entry in Table 1 below, and the counteranion employed are shown to the right of the amines.

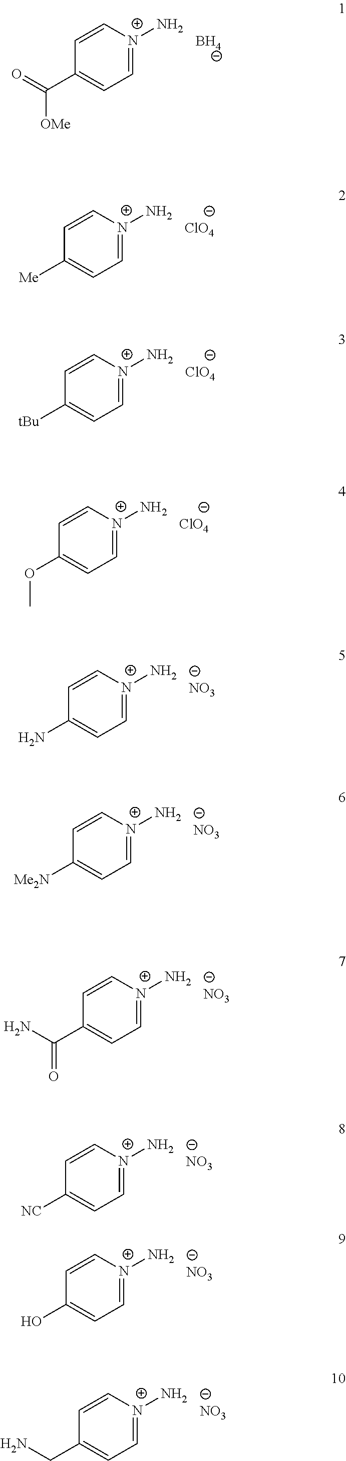

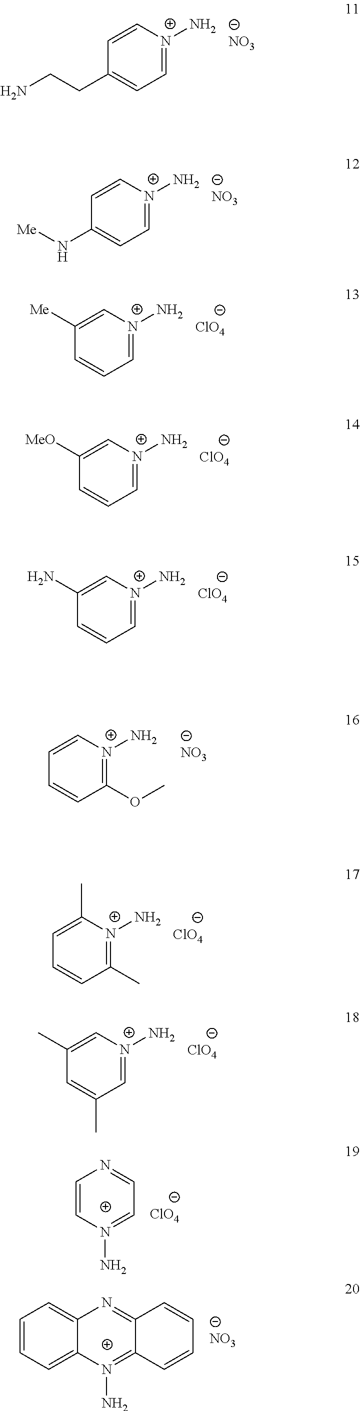

Each of structures 1-20 were assessed for electrochemical capture and release of carbon dioxide in accordance with the techniques described above in Example 1. Absorption capacities for carbon dioxide are reported in units of moles of CO₂ per mole of amine. In the capture experiments, 1 mL aqueous solutions of each amine entry at concentrations ranging from 0.1-0.2 M were electrochemically reduced and exposed to CO₂ inlet gas having a concentration of CO₂ of 15% and a flow rate of 3.3 mL/min. For the release experiments, 3.5 mL solutions of amine and captured carbon dioxide at concentrations ranging from 0.1-0.2 M of amine were electrochemically oxidized at a constant current of 50 mA while released CO₂ was measured as a function of charge passed. Table 1 provides a summary of the experiments and observations. In the “CO₂ exp. Data (absorb/release)” column, “Y” means that the experiment was performed and “N” means that the experiment was not performed.

TABLE 1
Summary of electrochemical carbon dioxide capture and release experiments with various amines.

| | | | | | | CO₂ exp. | | | |
|---|---|---|---|---|---|---|---|---|---|
| | | | Eₚ^{red} vs | Eₚ^{oxi} vs | | Data | | | |
| | | Counter | Ag/ | Ag/ | Potential | (absorb/ | | CO₂ | |
| Entry | R | anion | AgCl | AgCl | gap | release | ε_{CO2} | capacity | Observations |
| 1 | p-COOMe | BF₄⁻ | −0.34 | N/A | N/A | N/N | N/A | N/A | Did not |
| | | | V | | | | | | capture CO₂ |
| 2 | p-Me | ClO₄⁻ | N/A | N/A | N/A | N/N | N/A | N/A | N—N bond |
| | | | | | | | | | cleavage |
| | | | | | | | | | when |
| | | | | | | | | | reduced |
| 3 | p-t-Bu | ClO₄⁻ | −0.48 | 0.83 | 1.31 | N/Y | 0.52 | — | Low |
| | | | V | V | V | | | | solubility |
| | | | | | | | | | (<0.2M) |
| 4 | p-OMe | ClO₄⁻ | −0.70 | 1.05 | 1.75 | N/Y | 0.70 | — | Low |
| | | | V | V | V | | | | solubility |
| | | | | | | | | | (<0.2M) |
| 5 | p-NH₂ | NO₃⁻ | −0.48 | 1.02 | 1.44 | Y/Y | 0.99 | 2.3 | Water |
| | | | V | V | V | | | | splitting was |
| | | | | | | | | | observed |
| | | | | | | | | | when |
| | | | | | | | | | reduced |
| 6 | p-NMe₂ | NO₃⁻ | −0.43 | 0.85 | 1.28 | Y/Y | 0.99 | 2.0 | Water |
| | | | V | V | V | | | | splitting was |
| | | | | | | | | | observed |
| | | | | | | | | | when |
| | | | | | | | | | reduced |
| | | | | | | | | | Oxidation |
| | | | | | | | | | led to Me—N |
| | | | | | | | | | cleavage |
| 7 | p-CONH₂ | NO₃− | −0.49 | 0.88 | 1.37 | Y/Y | 0.69 | 1.1 | |
| | | | V | V | V | | | | |
| 8 | p-CN | NO₃⁻ | −0.55 | 0.88 | 1.43 | Y/Y | 0.70 | 1.65 | |
| | | | V | V | V | | | | |
| 9 | p-OH | NO₃⁻ | −0.56 | 0.85 | 1.41 | Y/Y | 0.32 | 0.95 | |
| | | | V | V | V | | | | |
| 10 | p-CH₂NH₂ | NO₃⁻ | N/A | N/A | N/A | N/N | N/A | N/A | Insoluble |
| | | | | | | | | | solid was |
| | | | | | | | | | formed when |
| | | | | | | | | | reduced |
| 11 | p-CH₂CH₂NH₂ | NO₃⁻ | N/A | N/A | N/A | N/N | N/A | N/A | No reduction |
| | | | | | | | | | peak |
| 12 | p-NHMe | NO₃⁻ | −0.47 | 0.87 | 1.34 | Y/Y | 0.91 | 1.6 | Water |
| | | | V | V | V | | | | splitting was |
| | | | | | | | | | observed |
| | | | | | | | | | when |
| | | | | | | | | | reduced |
| | | | | | | | | | Oxidation |
| | | | | | | | | | led to Me—N |
| | | | | | | | | | cleavage |
| 13 | n-Me | ClO₄⁻ | −0.47 | 1.00 | 1.47 | N/Y | 0.83 | — | |
| | | | V | V | V | | | | |
| 14 | m-OMe | ClO₄⁻ | −0.44 | 0.84 | 1.30 | N/Y | 0.41 | — | |
| | | | V | V | V | | | | |
| 15 | m-NH₂ | ClO₄⁻ | −0.70 | 1.03 | 1.73 | Y/Y | 0.72 | 1.1 | |
| | | | V | V | V | | | | |
| 16 | o-NH₂ | NO₃⁻ | −0.73 | 1.73 | 2.46 | Y/Y | 0.76 | 1.05 | |
| | | | V | V | V | | | | |
| 17 | 2,6-dimethyl | ClO₄⁻ | −0.43 | 1.04 | 1.47 | N/N | N/A | N/A | |
| | | | V | V | V | | | | |
| 18 | 3,5-dimethyl | ClO₄⁻ | −0.44 | 1.52 | 1.96 | N/N | N/A | N/A | |
| | | | V | V | V | | | | |
| 19 | 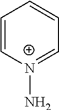 | ClO₄⁻ | −0.82 V | N/A | N/A | N/N | N/A | N/A | irreversible reduction peak N—N bond cleavage when reduced |
| 20 | 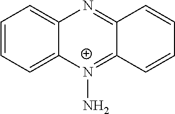 [SMILES: N[n+]1c2ccccc2nc2ccccc21] | NO₃⁻ | −0.45 V | N/A | N/A | N/N | N/A | N/A | Low solubility (<10 mM) |

As indicated by the results summarized in Table 1, numerous of the redox-amines evaluated were able to electrochemically capture and release carbon dioxide, while a few amines underwent irreversible electrochemical reactions and/or presented solubility difficulties (some of which could potentially be addressed via use of varying counteranions).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first.” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising electrochemically reacting an amine such that the amine becomes reactive with a target species.

2. A method, comprising electrochemically reacting an amine such that a target species is captured.

3. The method of claim 1, wherein the step of electrochemically reacting the amine is performed via a reduction reaction.

4. The method of claim 1, wherein the target species comprises a gaseous species.

5. The method of claim 1, wherein the target species comprises a Brønsted-Lowry acid or an anhydride of a Brønsted-Lowry acid.

6. The method of claim 5, wherein the amine becomes reactive with the target species at least in part due to having a pKₐ greater than or equal to a pKₐ of the Brønsted-Lowry acid following the electrochemically reacting step.

7. The method of claim 1, wherein the target species comprises carbon dioxide.

8. The method of claim 1, further comprising reacting the amine with the target species to capture the target species.

9. The method of claim 8, wherein the step of reacting the amine with the target species comprises one or more chemical reactions between the amine, the target species, and/or one or more reaction products formed by the target species.

10. The method of claim 8, wherein the step of reacting the amine with the target species comprises forming a Brønsted Lowry acid from the target species, protonating the amine, and forming a conjugate base of the Brønsted Lowry acid.

11. The method of claim 10, wherein the target species comprises carbon dioxide, the Brønsted Lowry acid comprises carbonic acid (H₂CO₃), and the conjugate base comprises bicarbonate (HCO₃⁻).

12. The method of claim 1, further comprising reacting the combination of the amine and the target species such that the target species is released from the amine.

13. The method of claim 12, wherein the step of reacting the combination of the amine and the target species is performed via an oxidation reaction.

14. The method of claim 1, wherein the amine is dissolved and/or suspended in a liquid solution during at least a portion of the method.

15. The method of claim 1, wherein the amine is dissolved and/or suspended in an aqueous solution during at least a portion of the method.

16. The method of claim 1, wherein the amine is a cationic species.

17. The method of claim 1, wherein the amine has a standard reduction potential for undergoing the electrochemical reaction that is equal to or more positive than −1.0 V vs. Ag⁺/AgCl at 298 K.

18. The method of claim 1, wherein the amine comprises a radical-stabilizing moiety.

19. The method of claim 1, wherein the amine comprises an optionally-substituted 1-aminopyridinium species.

20. The method of claim 1, wherein the method comprises capturing the target species as part of a direct air capture (DAC) process.

21. (canceled)

22. A system, comprising:
an electrode;
an amine in electronic communication with the electrode; and
an inlet configured to be in fluidic communication with a source of a target species;
wherein the system is configured to expose the target species to the amine.

23. (canceled)
